(19) United States
(12) Patent Application Publication
(10) Pub. No.: US 2010/0035655 A1
(43) Pub. Date: Feb. 11, 2010

(54) SYSTEM AND METHOD FOR CALLING A RADIO BROADCAST STATION WHILE REPRODUCING A RADIO BROADCAST

(75) Inventor: HAO-MING HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/346,883

(22) Filed: Dec. 31, 2008

(30) Foreign Application Priority Data
Aug. 8, 2008 (CN) 200810303635.3

(51) Int. Cl. H04M 1/00

(52) U.S. Cl. 455/564

(57) ABSTRACT

A system for calling a radio broadcast station while reproducing a radio broadcast searches for the radio broadcast station channel to reproducing the radio broadcast, stores information about the radio broadcast station and a telephone number of the radio broadcast station into a storage system of a radio unit. The system further selects the telephone number from the storage system to call the radio broadcast station during reproduction of the radio broadcast, discontinues reproducing the radio broadcast while maintaining the phone call with the radio broadcast station, and resumes reproducing the radio broadcast when the phone call with the radio broadcast station is not maintained.

### BACKGROUND

1. Technical Field

Embodiments of the present disclosure generally relate to systems and methods for operations of mobile phones, and more particularly, to a system and method for calling a radio broadcast station while reproducing a radio broadcast.

2. Description of Related Art

Presently, mobile phones are widely used because of their multifunctional services and other conveniences. A mobile phone can help people keep in contact with family and friends, and also can be used as a dictionary, a media player, a radio, and so on.

Conventionally, if a user wants to make a telephone call to a radio broadcast station using a mobile phone while listening to the radio broadcast using the mobile phone, the user needs to change the screen of the mobile phone from the radio unit to the telephone directory. After a phone call with the radio broadcast station is completed, the user needs to change the screen of the mobile phone back from the telephone directory to the radio unit for channel shifting or to turn off the radio unit. Switching the screen of the mobile phone so frequently brings great inconvenience to people.

Thus, a system and method for overcoming the aforementioned problem is needed.

### BRIEF DESCRIPTION OF THE DRAWINGS

FIG. 1 is a block diagram of one embodiment of a system for calling a radio broadcast station while reproducing a radio broadcast; and

FIG. 2 is a flowchart illustrating one embodiment of a method for calling a radio broadcast station while reproducing a radio broadcast.

### DETAILED DESCRIPTION OF CERTAIN INVENTIVE EMBODIMENTS

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

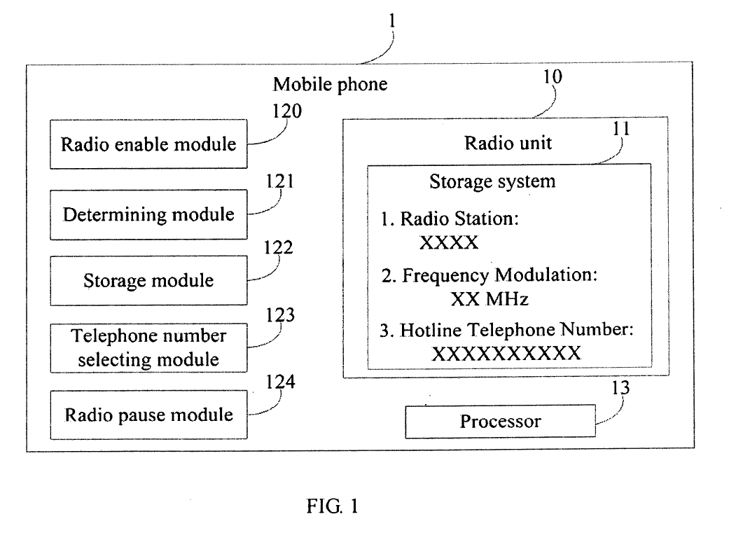

FIG. 1 is a block diagram of one embodiment of a system for calling a radio broadcast station while reproducing a radio broadcast. In one embodiment, the system may be a mobile phone 1. The mobile phone 1 includes a radio unit 10 and a processor 13. The radio unit 10 includes a storage system 11. The mobile phone 1 further includes a plurality of function modules. The function modules may be a radio enable module 120, a determining module 121, a storage module 122, a telephone number selecting module 123, and a radio pause module 124. It may be understood that the processor 13 of the mobile phone 1 can be used to execute one or more operations for the function modules 120, 121, 122, 123, and 124.

The radio enable module 120 is configured for invoking/enabling the radio unit 10, and searching for a radio broadcast station channel to reproduce a radio broadcast of the radio broadcast station through a speaker and/or headset of the mobile phone 1. The radio broadcast station may be, for example, BBC, VOA, and so on.

The determining module 121 is configured for determining if information of the radio broadcast station and a telephone number of the radio broadcast station have been stored in the storage system 11. It may be understood that, the information of the radio broadcast station may include a name of the radio broadcast station, and the channel, such as a frequency modulation (FM) bandwidth and/or an amplitude modulation (AM) bandwidth of the radio broadcast station. The telephone number of the radio broadcast station may be a hotline telephone number. The hotline telephone number may be a direct number to the corresponding radio broadcast station so as to enable calling to the radio broadcast station and avoiding computer-based answering systems in one example.

The storage module 122 is configured for storing the information and the telephone number of the radio broadcast station into the storage system 11 if the information and the telephone number are not stored in the storage system 11.

The telephone number selecting module 123 is configured for selecting the telephone number from the storage system 11 when it is necessary to call the radio broadcast station.

The radio pause module 124 is configured for temporarily discontinuing reproducing the radio broadcast while maintaining a phone call with the radio broadcast station. The radio pause module 124 is further configured for resuming reproducing the radio broadcast when the phone call with the radio broadcast station is not maintained.

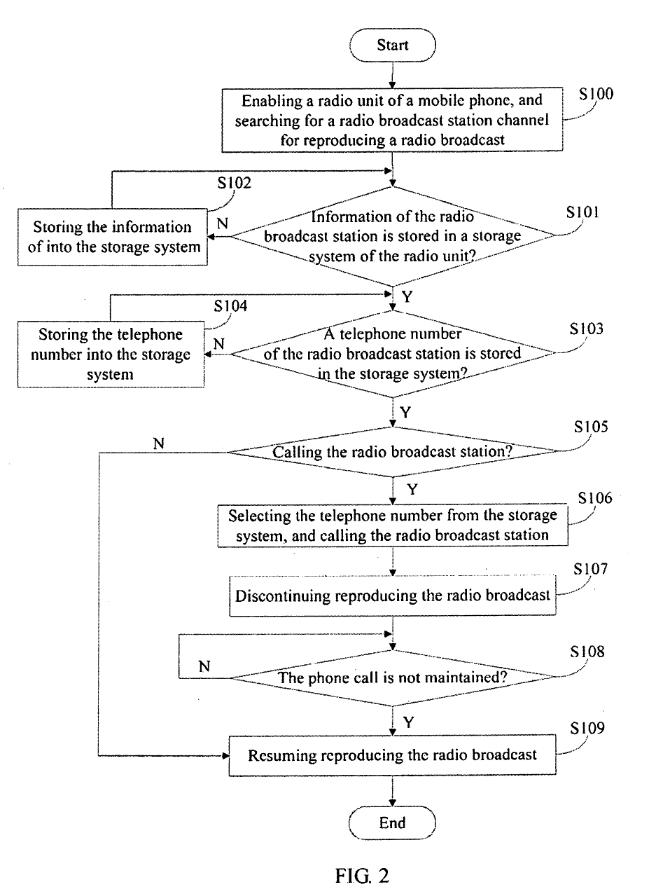

FIG. 2 is a flowchart illustrating one embodiment of a method for calling a radio broadcast station while reproducing a radio broadcast using the mobile phone 1. Depending on the embodiment, additional blocks in the flow of FIG. 2 may be added, others removed, and the ordering of the blocks may be changed.

In block S100, the radio enable module 120 invokes/enables the radio unit 10 of the mobile phone 1, and searches for a radio broadcast station channel that is reproducing a radio broadcast of the radio broadcast station.

In block S101, the determining module 121 determines if information about the radio broadcast station is stored in the storage system 11 of the radio unit 10. As mentioned above, the information may include a name of the radio broadcast station, and the channel, such as a frequency modulation (FM) bandwidth and/or an amplitude modulation (AM) bandwidth of the radio broadcast station. The flow moves to block S103 if the information of the radio broadcast station has been stored in the storage system 11. Otherwise, the flow goes to block S102 if the information is not stored in the storage system 11.

In block S102, the storage module 122 stores the information of the radio broadcast station into the storage system 11 of the radio unit 10.

In block S103, the determining module 121 further determines if a telephone number of the radio broadcast station has been stored in the storage system 11. The flow moves to block S105 if the telephone number has been stored in the storage system 11. Otherwise, the flow goes to block S104 if the telephone is not stored in the storage system. As mentioned above, the telephone number may be hotline telephone number.

In block S104, the storage module 122 stores the telephone number into the storage system 11.

In block S105, the determining module 121 determines if it is necessary to call the radio broadcast station. The flow comes to the end if it is not necessary to call the radio broadcast station. Otherwise, the flow moves to block S106. It may be understood that, if a user wants to consult the radio broadcast station about some questions or join in an activity given by the radio broadcast station, it is necessary to call the radio broadcast station.

In block S106, the telephone number selecting module 123 selects the telephone number from the storage system 11 of the radio unit 10, and calls the radio broadcast station using the selected telephone number.

In block S107, the radio pause module 124 temporarily discontinues reproducing the radio broadcast while the user is maintaining a phone call with the radio broadcast station.

In block S108, the radio pause module 124 determines if the phone call with the radio broadcast station is no longer being maintained (e.g., the user finishes the call with the radio broadcast station). The flow repeats block S109 if the phone call is no longer maintained. Otherwise, the flow moves to block S108.

In block S109, the radio pause module 124 resumes reproducing the radio broadcast. Because there is no need to manually switch from the radio unit to making a phone call with the radio broadcast station and because the radio broadcast station resumes playing after making the phone call to the radio broadcast station, time and inconvenience is saved.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for calling a radio broadcast station while reproducing a radio broadcast of the broadcast station, the system comprising:
a radio unit having a storage system;
a radio enable module configured for enabling the radio unit, and searching for the radio broadcast station channel to reproduce the radio broadcast of the radio broadcast station;
a storage module configured for storing information of the radio broadcast station and a telephone number of the radio broadcast station into the storage system;
a telephone number selecting module configured for selecting the telephone number from the storage system to call the radio broadcast station while reproducing the radio broadcast;
a radio pause module configured for temporarily discontinuing reproducing the radio broadcast while maintaining the phone call with the radio broadcast station, and for resuming reproducing the radio broadcast when the phone call with the radio broadcast station is not maintained; and
at least one processor that executes the radio enable module, the storing module, the telephone number selecting module, and the radio pause module.

2. The system as described in claim 1, wherein the information of the radio broadcast station comprises a name of the radio broadcast station, and frequency modulation and/or amplitude modulation of the radio broadcast station.

3. The system as described in claim 1, the system further comprising:
a determining module configured for determining if the information and the telephone number of the radio broadcast station have been stored in the storage system.

4. A method for calling a radio broadcast station while reproducing a radio broadcast of the broadcast station using a mobile phone, comprising:
enabling a radio unit of the mobile phone, and searching for the radio broadcast station channel for reproducing the radio broadcast of the radio broadcast station;
storing information of the radio broadcast station and a telephone number of the radio broadcast station into a storage system of the radio unit;
selecting the telephone number from the storage system while reproducing the radio broadcast;
calling the radio broadcast station using the selected telephone number; and
discontinuing reproducing the radio broadcast while maintaining the phone call with the radio broadcast station and resuming reproducing the radio broadcast when the phone call with the radio broadcast station is not maintained.

5. The method as described in claim 4, wherein the information of the radio broadcast station comprises a name of the radio broadcast station, and frequency modulation and/or amplitude modulation of the radio broadcast station.

6. The method as described in claim 4, before storing information further comprising:
determining if the information and the telephone number of the radio broadcast station have been stored in the storage system.

7. A storage medium having stored thereon instructions that, when executed by a processor, causing the processor to perform a method for calling a radio broadcast station while reproducing a radio broadcast of the broadcast station using a mobile phone, the method comprising:
enabling a radio unit of the mobile phone, and searching for the radio broadcast station channel for reproducing the radio broadcast of the radio broadcast station;
storing information of the radio broadcast station and a telephone number of the radio broadcast station into a storage system of the radio unit;
selecting the telephone number from the storage system while reproducing the radio broadcast;
calling the radio broadcast station using the selected telephone number; and
discontinuing reproducing the radio broadcast while maintaining the phone call with the radio broadcast station and resuming reproducing the radio broadcast when the phone call with the radio broadcast station is not maintained.

8. The storage medium as described in claim 7, wherein the information of the radio broadcast station comprises a name of the radio broadcast station, and frequency modulation and/or amplitude modulation of the radio broadcast station.

9. The storage medium as described in claim 7, before storing information the method further comprising:
determining if the information and the telephone number of the radio broadcast station have been stored in the storage system.
